(19) United States
(12) Patent Application Publication
(10) Pub. No.: US 2016/0175174 A1
(43) Pub. Date: Jun. 23, 2016

(54) Side Exiting Wheelchair

(71) Applicants: William Joseph Drasler, Minnetonka, MN (US); Richard Charles Kravik, Champlin, MN (US); Mark Lynn Jenson, Greenfield, MN (US); William Joseph Drasler, II, Minnetonka, MN (US)

(72) Inventors: William Joseph Drasler, Minnetonka, MN (US); Richard Charles Kravik, Champlin, MN (US); Mark Lynn Jenson, Greenfield, MN (US); William Joseph Drasler, II, Minnetonka, MN (US)

(21) Appl. No.: 14/578,470

(22) Filed: Dec. 21, 2014

(51) Int. Cl. A61G 5/10; A61G 5/02

(52) U.S. Cl. CPC A61G 5/10; A61G 5/02

(57) ABSTRACT

A wheel assembly for a wheel chair allows the occupant to transfer laterally without encountering obstruction from a fixed mobilization or transfer wheel. In one embodiment the wheel is slid rearward and locked to allow the occupant to transfer laterally in front of the slidable wheel. In another embodiment a chordal portion of the wheel is temporarily removed to allow transfer over the remaining portion of the wheel. Another embodiment enables the chair occupant to mobilize vertically to allow lateral transfer over a standard fixed mobilization wheel; alternately, a further embodiment allows the occupant to mobilize forward to allow lateral transfer in front of a standard fixed mobilization wheel.

### CROSS REFERENCE TO RELATED APPLICATIONS

This patent application makes reference to and thereby hereby incorporates all information found in the provisional patent application numbered Ser. No. 61/964,284 entitled Side Exiting Wheelchair, filed 30 Dec. 2013 by William J. Drasler, et. al., and found in provisional patent application numbered Ser. No. 61/955,827 entitled Side Exiting Wheelchair Device filed 21 Apr. 2014 by William J. Drasler, et. al.

### FIELD OF THE INVENTION

This invention relates to a wheelchair device that incorporates a novel means to eliminate the side barrier, such as a wheel obstruction, for example, so that the occupant can transfer into or out of the chair without having to transfer around or over the wheel. A number of embodiments are described for a wheelchair system that enables the occupant to remove the side barriers without assistance.

### BACKGROUND OF THE INVENTION

One of the common difficulties for wheelchair—bound individuals is the challenge they face when transferring to a fixed chair, toilet, car seat, or other platform. The only way they can perform the transfer is to stand up and exit the chair out the front, then pivot and sit down, hoping that they are on target.

Many aids have been developed to assist in the transfer process, but they are usually cumbersome, expensive, take too much time to employ, or require the assistance of a caregiver. Most wheelchair-bound occupants have enough strength to push themselves out of the chair, but not enough balance or leg strength to confidently execute the transfer without assistance. The resulting frustration at not being able to perform this frequent transfer maneuver diminishes the quality of life and increases the feeling of dependence of the wheelchair-bound individual.

If a reliable method for independent transfer can be developed, it would realize many significant benefits. From a safety perspective, the method would minimize the risk of falls and the long-term ramifications from unnecessary injuries. Additionally, cost-savings may be realized by reducing need for medical assistance and personal attendants. Being able to transfer oneself in an independent manner promotes confidence and raises self-esteem; it also assists in maintaining upper-body strength.

### SUMMARY

The present invention offers novel solutions for side-transfer of a wheelchair-bound individual that do not require assistance. Several embodiments of the invention are described which can be used to modify an existing wheelchair, used with an existing wheelchair, or can be included in the initial design of an improved wheelchair design. One of the embodiments comprises an occupant-actuated lift mechanism that removes the weight from the transfer or mobilization wheel so that the wheel can be rotated into the correct position or slid out of the way. This embodiment can be used with other embodiments of the invention in order to provide the other embodiments a greater level of utility via the operator. Other embodiments allow the occupant to transfer over a portion of the wheel or allow the wheel to be moved rearward so that the occupant can transfer in front of the wheel.

The method of operation allows the occupant to independently side-transfer from the wheelchair onto another platform or target location. The occupant accomplishes this task by removing the chair obstacles to side-transfer, such as its wheel, for example, and physically sliding their body across the now-clear pathway into the desired target location.

In one embodiment the method is described via the following steps. The occupant rolls the chair into the appropriate orientation in proximity to the target platform location. The occupant then activates the lift mechanism to stabilize the chair and raise the wheel located on the side of the chair intended for transfer slightly off the ground. The occupant removes the barrier presented by the wheel by rotating the wheel such that the separable chordal segment is rotated to the top of the rotation and removing or folding the chordal segment. The occupant may lower the wheel by raising the lift mechanism, or may leave the wheel in a freewheeling state during transfer of the occupant. The occupant slides himself or herself across the chair and onto the target platform.

In another embodiment the occupant wheels into position and raises the wheel on one side as described in the previous embodiment. The occupant is then able to slide the wheel rearward to allow the occupant to transfer to the target location in front of the wheel.

In one embodiment of the present invention both of the wheels have a removable chordal segment of such a dimension as to remove the obstruction that the wheel would present during side-transfer. In this embodiment the wheel segment is removed by the occupant and set aside. The structure of this embodiment is such that, when assembled, the chordal segment matches up to the non-chordal segment to ensure that the resulting wheel perimeter is round and smooth. A pair of alignment pins is used to establish the connection between the chordal and non-chordal segments. The pins may be located in either segment, or may have one pin in one segment and the second pin in the other segment, and will match up with a pair of holes (one hole may be elongate to facilitate ease of assembly or removal) in the opposite segment. The pins have a locking mechanism that locks the two segments together when activated by the occupant. In this embodiment, a lift mechanism can be incorporated as an integral part of the wheel that, when activated, raises the wheel slightly off the ground to permit the occupant to rotate the wheel such that the chordal segment is at the top of the rotation. The lift mechanism may consist of a toggle mechanism that is operated manually by means of a lever by the occupant. The toggle mechanism frame is incorporated as a concentric member of the wheel such that it does not add to the overall width of the wheelchair, and is mechanically anchored to the stock frame to provide stability and to prevent the lift mechanism from inadvertently rotating during operation. The lift may, or may not, be deactivated once the wheel has been rotated to the top at the preference of the occupant. A variant of the first embodiment, the wheel chordal segment pivots out of the way by means of a hinged joint but remains attached to the main body of the wheel. The occupant releases a locking mechanism and folds the segment over out of the plane of the wheel. Alternatively, the hinge (60) may be located at one end of the chordal segment with the hinge pin oriented perpendicular to the plane of the wheel, allowing the occupant to pivot the segment in the plane of the wheel such that the segment ends up behind the non-chordal segment.

In yet another embodiment, the wheel can be comprised of more than one chordal segment each of which can be attached to the main non-chordal segment of the wheel. For example, three chordal segments can be attached to generally triangular-shaped wheel to form a circular wheel. Removal of any one of the chordal segments provides the wheelchair occupant with an improved positioning of the appropriate chordal segment that would allow the occupant to transfer laterally from the wheelchair.

An alternate embodiment of the present invention has a solid wheel connected to a sliding mechanism that permits the occupant to slide the wheel back and out of the way. The sliding mechanism consists of two main elements, a fixed member that consists of a linear bearing surface and a mounting means to attach the fixed base to the wheelchair frame, and a sliding member. The sliding member consists of a linear bearing surface, low-friction sliding means (either rolling elements or low-friction material), a lock mechanism for preventing the slide from functioning at either end, or at any intermediate position, of the sliding member, and a means to attach the axle of the wheel to the sliding member. An integral lift mechanism can be built into the fixed member; the lift mechanism can be powered or operated by the occupant.

The fixed member is constructed in such a manner as to permit it to be attached to most stock wheelchair frames without requiring modification of the stock frame. One means to attach the fixed member to a stock frame would be to use strategically placed bolt holes along the length of the fixed member such that a U-bolt may be passed around the tubular members of the stock frame and through the appropriate hole pattern in the fixed member. The fixed member also is the base to which the lift mechanism and the linear bearing are attached. The linear bearing is the carrier of the rolling or sliding elements and the sliding member.

The lift mechanism may be either powered or manually operated by the occupant. If powered, the lift mechanism may consist of a coarse-thread jackscrew driven by a nut that is rotationally connected to a motor drive. Alternatively, the motor may drive a linkage that moves a lift leg up and down to accomplish the task of raising the wheel. If the lift mechanism is manually operated by the occupant, it is powered by the occupant raising or lowering a lever to operate a toggle linkage to raise and lower the lift leg. The toggle mechanism is designed to only require a force easily generated by an average wheelchair bound individual to accomplish the raising of the wheel off the ground.

The sliding member permits the occupant to move the wheel forward or back in order to position it in the desired location, either for normal use or for transfer. The sliding member also contains a lock mechanism, which enables the occupant to lock or unlock the wheel in any position relative to the wheelchair frame along the slidable length of the linear bearing. The sliding member includes a structure that connects the stock wheel to the sliding member by means of an axle. The axle may be the original axle or it may need to be a modified custom axle that is designed to mate to the sliding member.

In one embodiment of the sliding wheel, a locking means is placed onto the front wheel of the wheel chair on the side that the occupant wishes to transfer. Rotation of the large mobilization or transfer wheel in a rearward direction is used to allow the wheel to slide rearward and provide access for the occupant for transfer.

In still another embodiment of the invention a sliding seat is placed on top of the chair sitting base that would allow the wheelchair occupant to easily slide forward in the wheelchair to a position that would allow lateral transfer of the occupant in front of the transfer wheel. The chair base can be a planar member or soft foldable member that is placed onto the wheelchair frame after the wheelchair has been unfolded into its normal wheelchair width; the chair base forms a solid base onto which a sitting pad or cushion can be placed to provide a sitting surface for the occupant. An alternate movable caster wheel can be positioned at the front of the wheelchair to ensure that the wheelchair is stable against a forward rotation of the wheelchair during lateral transfer.

In still yet another embodiment of the invention a raised seat assembly is placed on top of the wheelchair sitting base that would allow the wheelchair occupant to become elevated to a location above the transfer wheel of the wheelchair to allow lateral transfer without obstacle from the transfer wheel. The raised seat assembly can be activated by an air bladder that is inflated during transfer. Alternately a mechanical lifting mechanism can be used to provide the elevation of the raised seat.

It is understood that any of the embodiments of the present invention can be combined with other embodiments to form a system to provide lateral transfer from a wheelchair. For example, the present invention could include a rearward sliding wheel with a forward sliding seat (or raising seat) such that each aspect of the invention contributes a portion of the benefit that provides for lateral transfer for the wheelchair occupant.

### BRIEF DESCRIPTION OF THE DRAWINGS

FIG. 1A is a plan view of a transfer wheel with chordal segment removable from a non-chordal segment via pins.

FIG. 1B is a plan view of a transfer wheel with chordal segment removable from a non-chordal segment via interlocking surfaces.

FIG. 1C is a plan view of a transfer wheel with chordal segment removable from a non-chordal segment via a cam lock assembly.

FIG. 1D is a side view of a wheelchair with a transfer wheel that has a chordal segment removed.

FIG. 2A is a transfer wheel with a hinged chordal segment in a latched configuration that can rotate within the plane of the transfer wheel.

FIG. 2B is a transfer wheel with a hinged chordal segment in an open configuration that is rotated within the plane of the transfer wheel.

FIG. 2C is a transfer wheel with a hinged chordal segment in an open configuration that is rotated out of the plane of the transfer wheel.

FIG. 3A is a plan frontal view of a wheelchair having a slide assembly that allows rearward movement of the transfer wheel.

FIG. 3B is a plan side view of a wheelchair having the transfer wheel attached to a slide assembly and the transfer wheel positioned in the standard position for mobilization of the chair or sitting in the chair.

FIG. 3C is a plan side view of a wheelchair having the transfer wheel attached to a slide assembly and the transfer wheel positioned in the rearward position for lateral transfer of the occupant.

FIG. 4A is a frontal view of a wheelchair having a motorized jackscrew lift mechanism.

FIG. 4B is a plan view of a lift mechanism consisting of a motorized jackscrew.

FIG. 5A is a plan frontal view of a wheelchair having a manual lift mechanism.

FIG. 5B is a plan view of a manual lift mechanism with a toggle linkage in a raised position.

FIG. 5C is a plan view of a manual lift mechanism with a toggle linkage in a lowered position to lift the transfer wheel off of the ground.

FIG. 6A is a frontal view of a wheelchair with motorized jackscrew lift mechanism and the transfer wheel attached to a slide assembly in a rearward position.

FIG. 6B is a side view of a wheelchair with motorized jackscrew lift mechanism and the transfer wheel attached to a slide assembly in a rearward position.

FIG. 7A is a frontal view of a wheelchair with a manual toggle lift mechanism and the transfer wheel attached to a slide assembly in a rearward position.

FIG. 7B is a side view of a wheelchair with a manual toggle lift mechanism and the transfer wheel attached to a slide assembly in a rearward position.

FIG. 8 is a transfer wheel with multiple chordal segments that are attached via pins to a non-chordal segment.

FIG. 9A is a side view of a wheelchair having a sliding seat assembly with the sliding seat in a standard sitting or mobilization position.

FIG. 9B is a side view of a wheelchair having a sliding seat assembly with the sliding seat in a forward position for lateral transfer of the occupant.

FIG. 10A is a side view of a wheelchair having a raised seat assembly with a raised seat in a lowered position for occupant sitting or mobilization.

FIG. 10B is a side view of a wheelchair having a raised seat assembly with a raised seat in a raised position for lateral transfer of the occupant.

FIG. 10C is a close-up view of a portion of a raised seat assembly showing an air supply attached to a bladder via an air tube and a valve.

FIG. 11A is a plan view of a wheel assembly having a transfer wheel attached to a slide assembly, and having an unlocked slide-lock assembly, and having an unlocked wheel-lock assembly.

FIG. 11B is a plan view of a portion of a wheel assembly showing a slide assembly, a locked slide-lock assembly via pins, and an unlocked wheel-lock assembly.

FIG. 11C is a plan view of a portion of a wheel assembly showing a slide assembly, a locked slide-lock assembly via pins, and a locked wheel-lock assembly.

FIG. 12A is a plan view of a portion of a wheel assembly showing a slide assembly and an unlocked slide-lock assembly that has a slide toggle.

FIG. 12B is a plan view of a portion of a wheel assembly showing a slide assembly and a locked slide-lock assembly having a slide toggle and slide tang.

FIG. 13A is a side view of a wheelchair having a transfer wheel attached to a slide assembly in a rearward position and a slidable lever located in a rearward position along a horizontal frame portion locking the transfer wheel from rotational motion.

FIG. 13B is a side view of a wheelchair having a transfer wheel attached to a slide assembly in a forward position and a slidable lever located in a forward position along a horizontal frame portion locking the transfer wheel from rotational motion.

### DETAILED DESCRIPTION OF THE INVENTION:

The present invention is a wheel assembly that can be affixed to an existing wheelchair (20), the design of which permits the main mobilization wheel to either be rotated into alignment and a portion of the wheel to be removed, the wheel slid back out of the way, or the seat of the wheelchair slid forward or upward such that the wheel is not an obstacle for the occupant to side transfer out of the chair. The invention is understood to apply to both mobilization wheels of a conventional manpowered wheelchair.

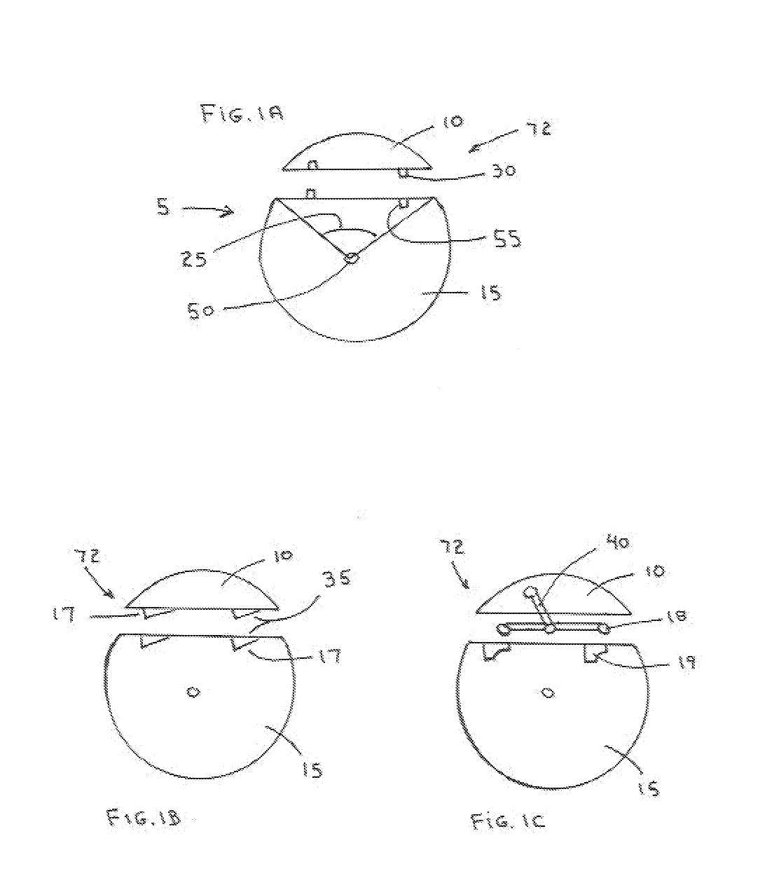

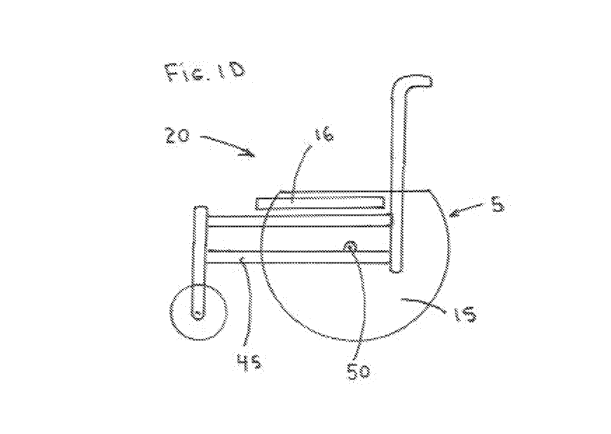

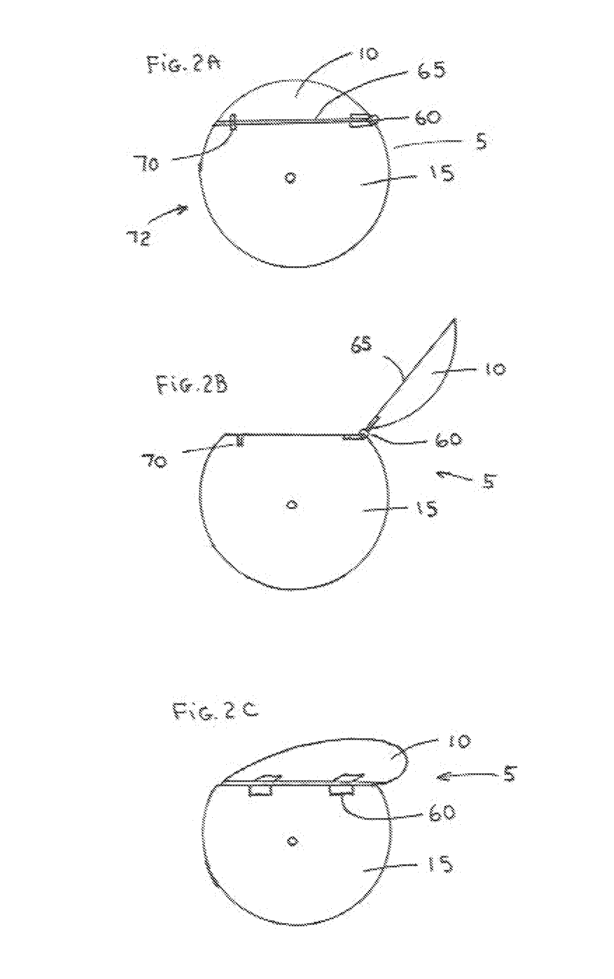

In one embodiment of the present invention, shown in FIGS. 1A to 2B, the wheel assembly (72) for a wheelchair (20) is comprised of a mobilization wheel or transfer wheel (5) is divided into a chordal segment (10) and a non-chordal segment (15). The chordal segment (10) is either removed or manipulated out of the way. The chordal segment (10) is of such a dimension that, when removed or retracted, the remaining non-chordal segment (15) of the wheel does not interfere with the occupant side-exiting the wheelchair (20) laterally from the seat pad, seat cushion, or seat support (16) as shown in FIG. 1D. The chordal segment (10) comprises a portion of the mobilization wheel of the wheelchair (20) with a chordal angle (25) ranging from 90-180 degrees; a chordal segment (10) of 110-170 degrees is preferred.

The chordal segment (10) is connected to the non-chordal segment (15) by any number of mechanical attachment methods, all of which would be designed for ease of removal, alignment, and reattachment by the occupant. Alignment and retention pins (30), sliding interlocking surfaces (35), and cam locks (40) are just a few of the means by which the two wheel segments could be fastened together.

As shown in FIGS. 1A to 2B, the mobilization wheel or transfer wheel (5) is divided into a smaller, separable chordal segment (10) and a larger non-chordal segment (15). The larger non-chordal segment (15) is affixed to the wheelchair frame (45) by means of either the original axle (50) or a new axle (50) designed to work with the present invention. The removable chordal segment (10) is keyed to the non-chordal segment (15) by means of locator pins (30) fitting into mating locator holes (55). Alternatively, the chordal segment (10) is aligned and affixed to the non-chordal segment (15) by means of a pair of inclines (17) that form interlocking surfaces (35) that clamp the two segments together. Alternatively, the chordal segment (10) is aligned and affixed to the non-chordal segment (15) by means of a cam latch mechanism or cam locks (40) that locks a rotating cam (18) into a cam seat (19). It is understood that any means can be used to hold the chordal segment (10) into position adjacent the non-chordal segment (15) without deviating from the present invention. When assembled, the wheel is round and the seams are matched up so that there is no irregularity in the rolling of the wheel. The wheel assembly (72) includes the chordal and non-chordal segments (15) of the transfer wheel (5). When disassembled, the chordal segment (10) is of a size that the remaining non-chordal segment (15) will not interfere with the side transfer of the occupant.

FIGS. 2A and 2B show an alternative embodiment of the wheel assembly (72) of the present invention. In this case, the separable chordal segment (10) of FIG. 1 is attached to the non-chordal segment (15) by means of a hinge (60) located at one end of a chordal line (65) that allows the chordal segment (10) to rotate to the side within the plane of the transfer wheel (5) as shown in FIG. 2B. The hinge (60) retains the positioning alignment of the chordal segment (10) to the non-chordal segment (15) when the chordal segment (10) is moved out of the way. The chordal segment (10) can be held to the non-chordal segment (15) via a latch (70). As shown in FIG. 2C the chordal segment (10) can alternately pivot by means of one or more hinges (60) located along the chordal line (65) such that the chordal segment (10) is able to fold out of the plane of the transfer wheel (5).

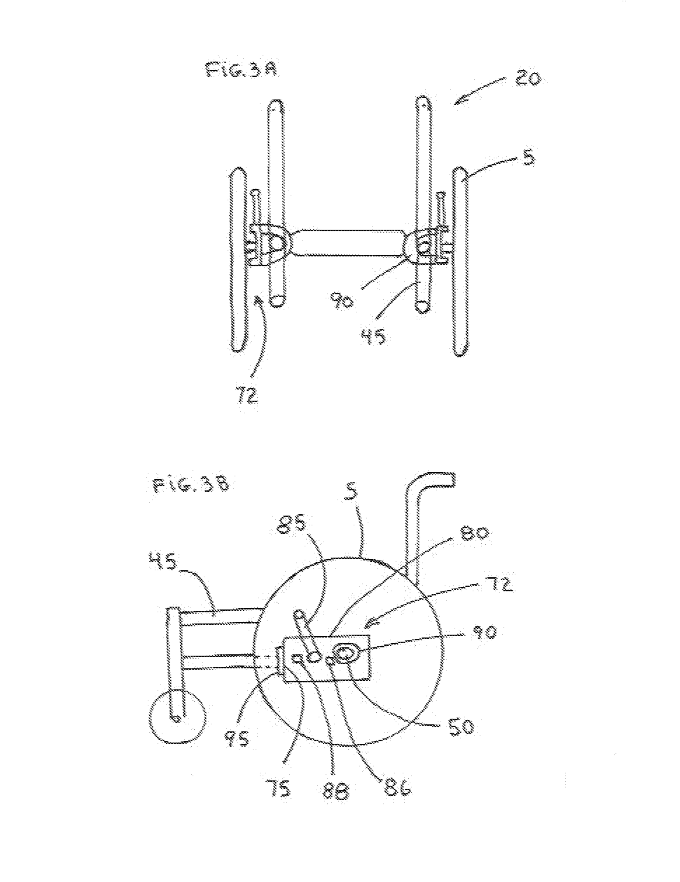

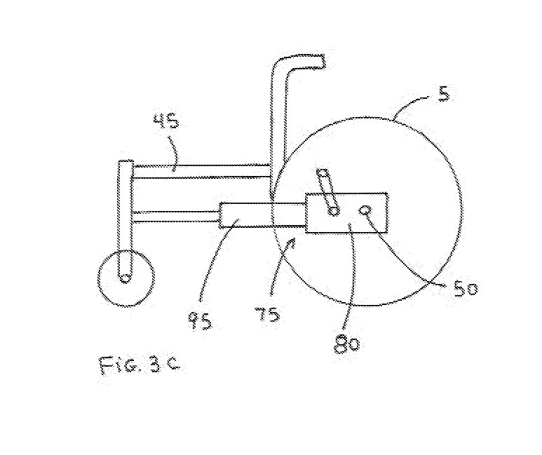

Another embodiment of the wheel assembly (72), shown in FIGS. 3A-3C, comprises the stock mobilization wheel or transfer wheel (5) connected to a slide assembly (75) that permits the transfer wheel (5) to slide to the rear of the wheelchair (20) from a standard position shown in FIG. 3B to a rearward position shown in FIG. 3C. The slide assembly (75) is a part of the wheel assembly (72) and is designed to easily attach to the wheelchair frame (45) by the wheelchair occupant or purchaser without requiring modification of the wheelchair frame (45). The slidable member (80) has a locking lever (85) that activates locking elements that allow the sliding member to remain fixed at a desired location with respect to a fixed member (95), either forward for normal usage or rearward during occupant lateral transfer. The slidable member (80) also has a mount (90) for accepting the axle (50) of the stock wheel.

The fixed member (95) consists of a plate that can be connected to the wheelchair frame (45) without requiring the frame (45) to be modified, and a bearing surface on which the slidable member (80) is moved back and forth relative to the fixed member (95) by the occupant.

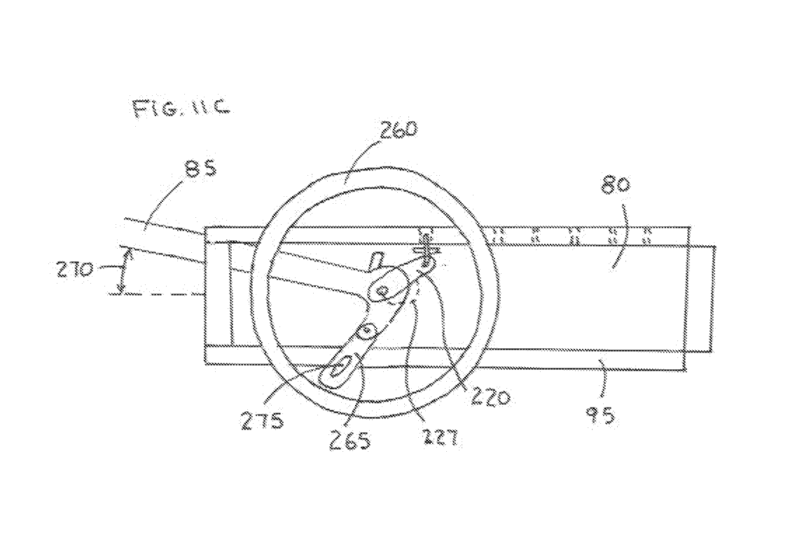

The embodiment for the wheel assembly (72) shown in FIGS. 3A-3C of the present invention that incorporates the slide assembly (75) allow the occupant to move the transfer wheel (5) to the rear of the wheelchair frame (45) to allow transfer of the occupant to the side without obstruction from the transfer wheel (5) as shown in FIG. 3C. It is noted that the slide assembly (75) can also allow both transfer wheels (5) to be moved forward from a standard wheel location (as found on standard wheelchairs) with respect to the wheelchair frame (45). Such forward location for the transfer wheels (5) provides the occupant with less strain on the shoulder muscles and tendons that can occur due to reaching back to grasp the wheel during chair mobilization. The sliding member is affixed to an axle (50) connected to the stock transfer wheel (5) and the fixed member (95) is affixed to the stock wheelchair frame (45). The sliding member is manually locked to the fixed member (95) by activating a slide-lock lever (85) that activates a slide-lock assembly (86) by the occupant to position and lock the slidable member (80) with respect to the fixed member in any position along the length of the slide assembly (75). The slidable member can be held to the fixed member (95) by either rolling elements such as ball bearings, for example, or a fitted slide (dovetail, square rail or the like) coated with a friction-reducing substance. The slide-lock lever (85) can, upon activation by the occupant, activate the wheel-lock assembly (88) to prevent the transfer wheel (5) from rotational movement (see also FIGS. 11A-11C).

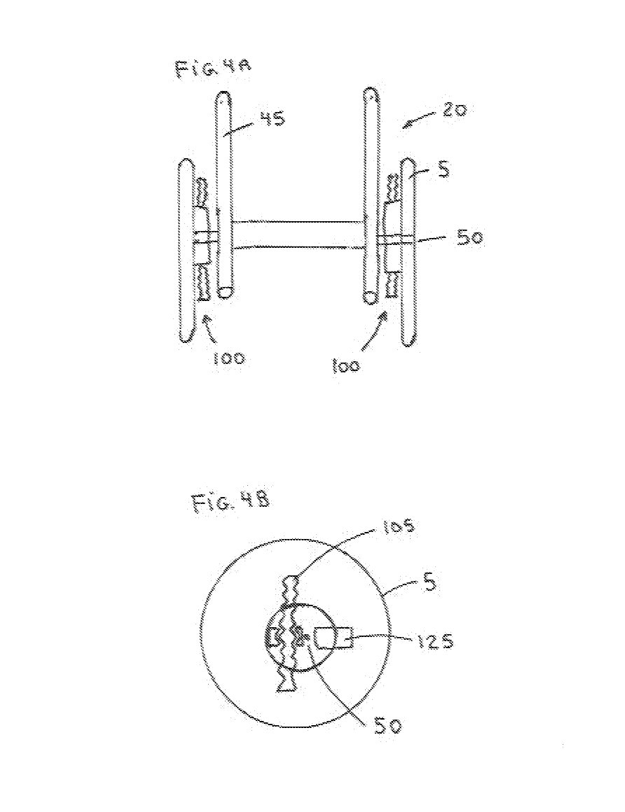

In the embodiments shown in FIGS. 1A-3C the wheel assembly (72), slide assembly (75), or wheelchair frame (45) can include an integral lift mechanism (100) (as shown in FIGS. 4A-7B) such that the lift mechanism (100) does not require the existing wheelchair frame (45) to be modified.

One embodiment of the lift mechanism (100) is a motorized mechanism shown in FIGS. 4A-4B that consists of a motor (125), battery, switch, wiring, and a jackscrew (105), toggle, or scissors lift that will take the weight off of the wheel for either rotational orientation or enablement of the wheel to be slid out of the way.

FIGS. 4A and 4B show the transfer wheel (5) with the integral lift mechanism (100) illustrated as a concentric part of the axle (50) assembly. In this illustration, the lift mechanism (100) is activated by a battery-powered motor (125) through a rotating lift jackscrew (105). An extension from the lift mechanism (100) is attached to the wheelchair frame (45) to ensure that the lift mechanism (100) does not rotate unintentionally while it is supporting the weight of the occupant. The jackscrew (105) centerline may be in front of the wheel axle (50) center, on the wheel axle (50) center, or behind the wheel axle (50) center.

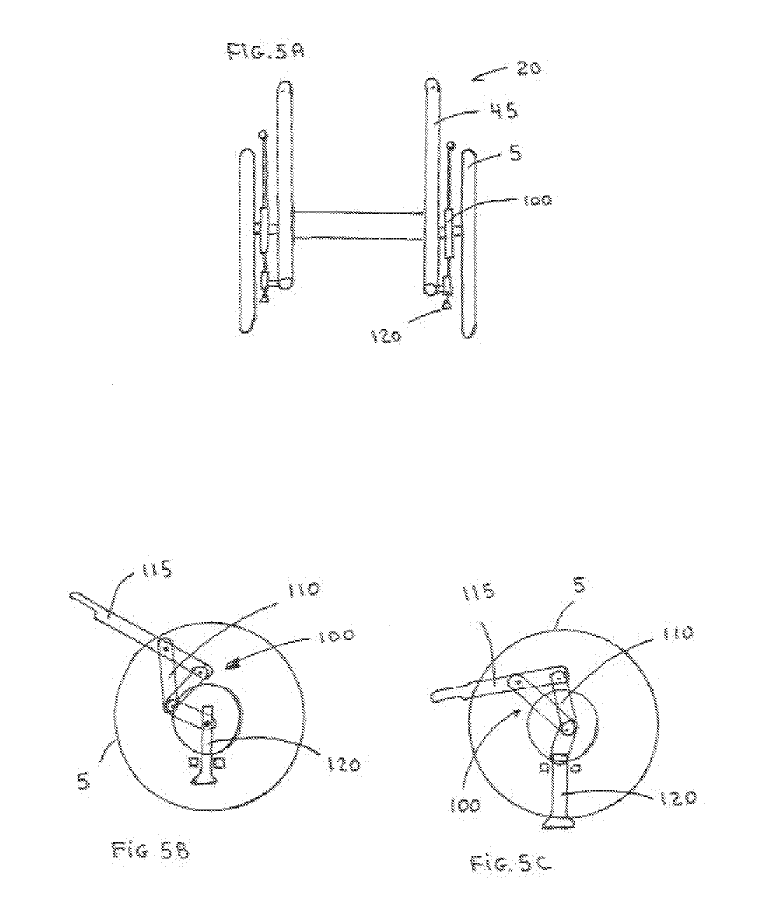

An alternate embodiment of the lift mechanism (100) shown in FIGS. 5A-5C is a toggle or toggle linkage (110) that is manually operated by a lever (115). The mechanism for the toggle linkage (110) is located between the wheelchair frame (45) and the transfer wheel (5), and when activated, lowers a leg or lift arm (120) that raises the transfer wheel (5) on the same side as the mechanism. In this alternate embodiment of the concentric wheel lift mechanism (100) where the lift action is accomplished by the occupant manually activating a lift lever (115) that moves the lift arm (120) by means of an intermediate mechanism. The intermediate mechanism can be a force-multiplying toggle linkage (110) or a four-bar linkage that is attached to the slide mechanism (75) and raises the transfer wheel (5) slightly off the ground.

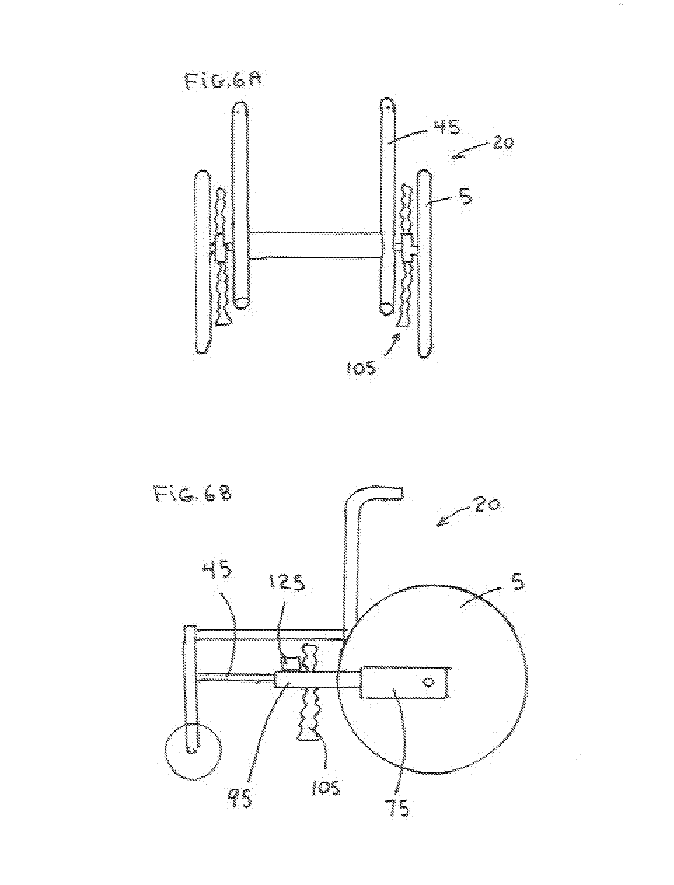

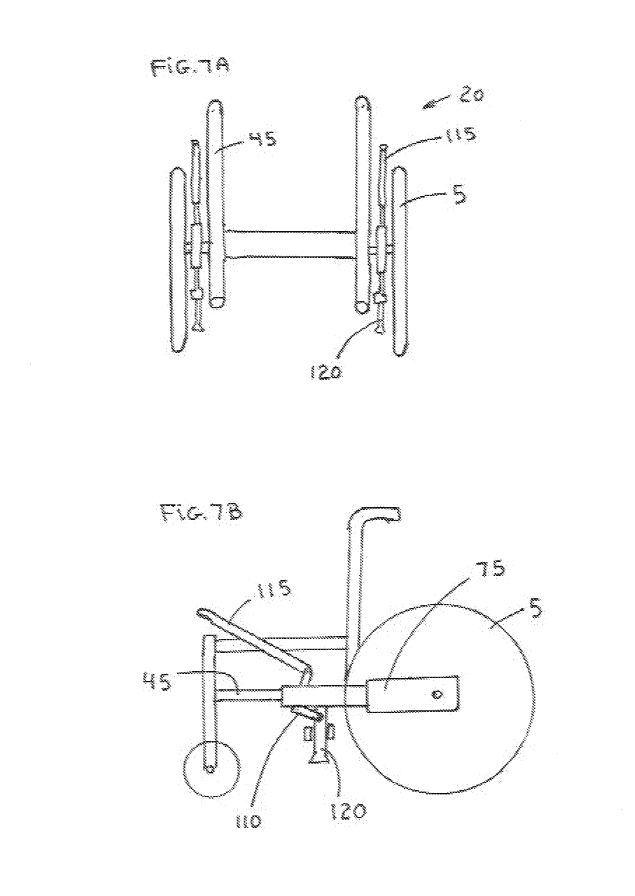

FIGS. 6A and 6B show the transfer wheel (5) with the integral lift mechanism (100) illustrated as a part of the slide mechanism (75). In this illustration, the lift mechanism (100) connected to the fixed member (95) and is activated by a battery-powered motor (125) through a rotating lift jackscrew (105).

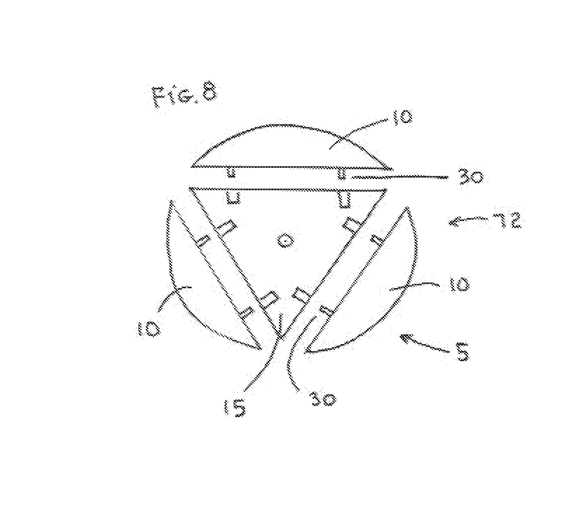

FIGS. 7A and 7B show an alternate embodiment of the lift mechanism (100) mounted on the slide mechanism (75) where the lift action is accomplished by the occupant manually activating a lift lever (115) that moves the lift arm (120) by means of an intermediate mechanism. The intermediate mechanism can be a force-multiplying toggle linkage (110) or a four-bar linkage that is attached to the slide mechanism (75) and raises the transfer wheel (5) slightly off the ground.

FIG. 8 shows an embodiment for a transfer wheel (5) of the present invention having three chordal segments (10) that are attached to a triangular-shaped non-chordal segment (15). Each of the chordal segments (10) is attached to the non-chordal segment (15) via locating pins (30), hinges (60), or other means as described in prior embodiments of this specification. As the wheelchair occupant is located in proper position for transfer, the chordal segment (10) that is providing the greatest obstacle to lateral transfer is removed or pivoted out of the way to allow for lateral transfer of the occupant.

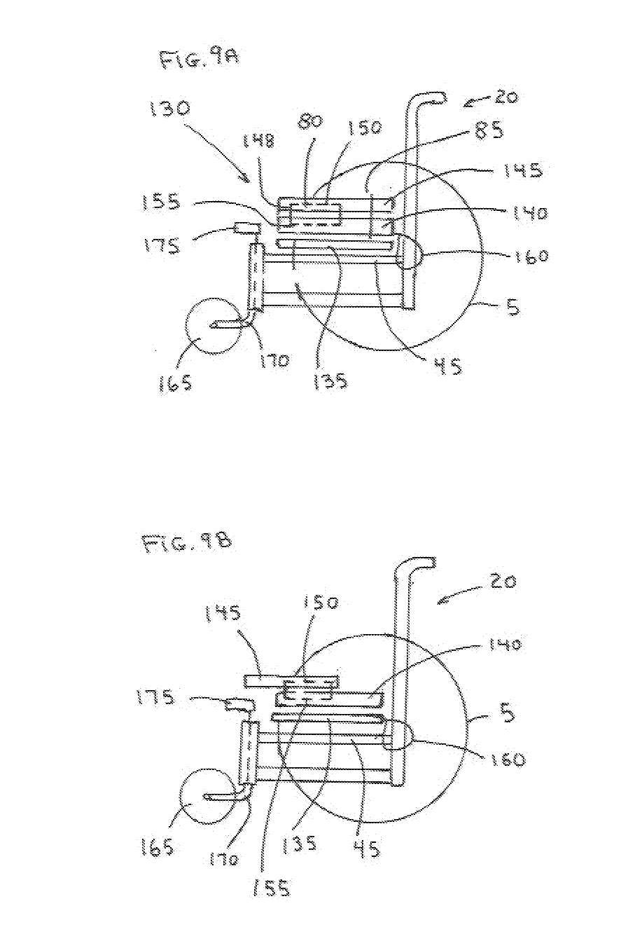

FIGS. 9A-9B show an embodiment for a sliding seat assembly (130) that can be placed upon the chair base (135); the chair base (135) provides the normal support between the chair frame and the occupant or cushion pad on which the occupant would normally sit. The chair base (135) can be a fabric material that folds when the chair is folded; alternately the chair base (135) can be a stiff board or solid structure that is placed or fitted onto the chair frame and is removed when the chair is folded for storage or when the chair is not in use. The sliding seat assembly (130) is comprised of a fixed platform (140) that is held adjacent to and slides with respect to a sliding seat (145) as shown in FIG. 9A. The sliding seat (145) is slidingly attached to the fixed platform (140) via a slide mechanism (148). The slide mechanism (148) can be comprised of a first member (150) that is attached to the sliding seat (145) and a second member (155) that is attached to the fixed platform (140). The slide mechanism (148) can include a low friction bearing surface between the first member (150) and second member (155); alternately roller bearings or other sliding means can be used. The slide mechanism (148) has a locking means to hold the sliding seat (145) in a rearward position as shown in FIG. 9A or in a forward position for transfer as shown in FIG. 9B. The fixed platform (140) is placed on top of the chair base (135) and is attached to the chair frame at the rear of the chair with attachment fixtures (160). The attachment fixtures (160) can be metal clamps or Velcro holding straps, for example. The sliding seat (145) is able to slide forward by 3-12 inches with respect to the fixed platform (140) to allow the wheelchair occupant to locate himself in front of the transfer wheel (5) as shown in FIG. 9B, and allow lateral transfer without obstacle from the transfer wheel (5).

The fixed platform (140) of the sliding seat assembly (130) can be formed from a polymeric, wood, or metal material to provide the strength required to support the sliding seat (145), which can be formed from similar materials. The fixed platform (140) can also be used to provide the function of the chair base (135) if desired, thereby eliminating the need for a separate chair base (135). The fixed platform (140) can be fitted with appropriate fixtures to allow it to attach, or fit, or be placed directly onto the frame (45) of the wheelchair (20).

To provide additional stability against possible forward rotation of the chair during transfer, the wheel caster (165) located at the front of the wheelchair (20) is positioned such that it extends forward with the greatest extent. The wheel caster (165) can be constructed with a larger pivoting arm (170) if necessary to provide additional stability in the forward direction. The wheel caster (165) can be directed to a forward position using a caster lever (175) that is conveniently located for access from the wheelchair occupant.

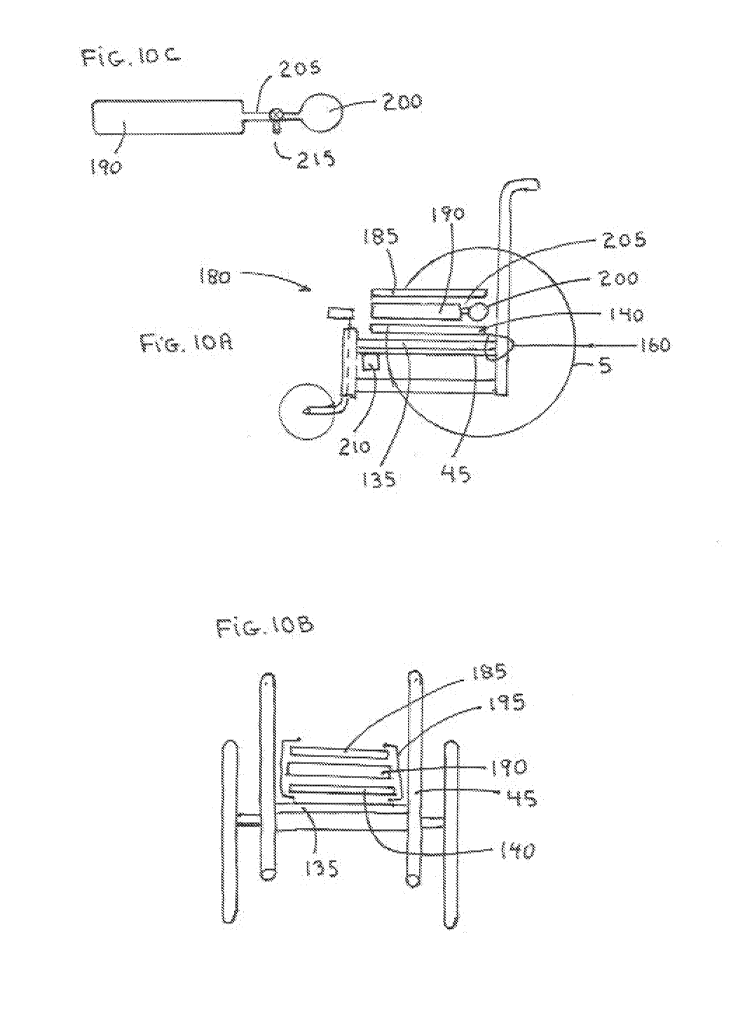

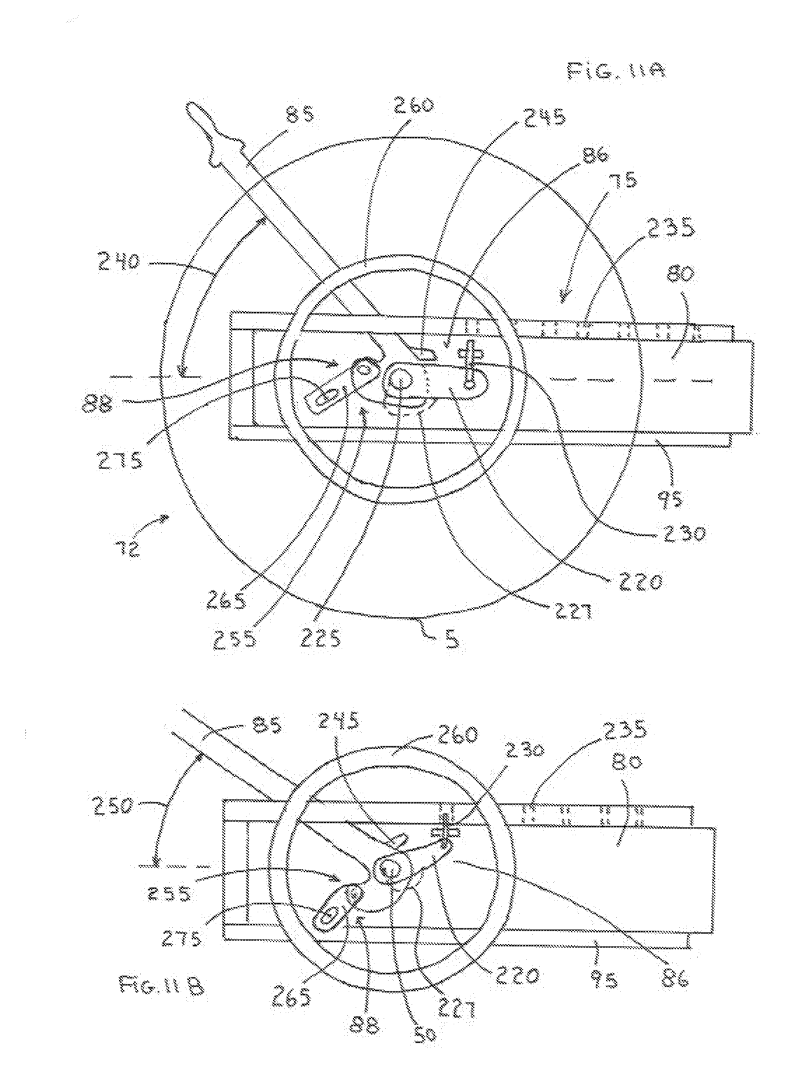

Another embodiment of the present invention is shown in FIGS. 10A-10C. In this embodiment a raised seat assembly (180) is placed onto the chair base (135) to raise the wheelchair occupant upwards to avoid the obstacle of the transfer wheel (5) during lateral transfer. The raised seat assembly (180) is comprised of fixed platform (140) that is coupled to a raised seat (185) with an inflatable bladder (190) located in between. The fixed platform (140) can be attached, if desired, to the wheelchair frame (45) via an attachment fixture (160) such as Velcro straps or clamps. The bladder (190) can be attached to both the raised seat (185) and the fixed platform (140) via an adhesive, if desired, to provide stability to the raised seat assembly (180) structure.

Upon inflation of the bladder (190) the raised seat (185) will change its height relative to the ground by approximately 3-6 inches (range 2-8 inches) to raise the wheelchair occupant such that the transfer wheel (5) is no longer providing an obstacle to lateral transfer as shown in FIG. 10B. A stop element (195) can extend from the raised seat (185) to the fixed platform (140) to ensure that the distance of travel of the raised seat (185) relative to the fixed platform (140) is both uniform and also provides a solid stable structure from which the wheelchair occupant can use as a solid base from which to transfer. The stop element (195) can be formed from straps, or flexible fabric, for example, that extend from the raised seat (185) to the fixed platform (140); when the straps become taught, the raised seat (185) surface will be firm and provide a stable transfer base.

The fixed platform (140) of the raised seat assembly (180) can also serve as the chair base (135) and can be positioned directly upon the wheelchair frame (45) thereby obviating the need for an additional chair base (135). The bladder (190) for the raised seat assembly (180) can be formed from a polymeric material such that those used in the formation of seat cushions for wheelchairs, air mattresses, air inflated bed mattresses, inflatable devices, and the like. The bladder (190) can be supported with fibers if desired to hold the shape and provide for improved stability for the bladder (190) in an inflated condition. The bladder (190) can be formed from a variety of plastics or rubbers that will hold pressures similar to that of an adult; such materials used in air mattresses would be appropriate, for example. The fixed platform (140) and raised seat (185) can be formed from a polymeric, wood, or metal material that is able to provide the support typically provided by a chair base (135) material that is placed or fit onto the chair frame and removed during folding of the chair.

Inflation of the bladder (190) can be accomplished by a disposable carbon dioxide compressed gas cartridge, a compressed gas cylinder, an electrically or battery operated air pump, mechanical pump, or another air supply (200). In one embodiment small compressed air tank (200) is attached to the raised seat (185) assembly (180) or to the frame (45) of the wheelchair (20). An air tube (205) connects the bladder (190) with the compressed air cylinder (200). The compressed air cylinder (200) has a volume of approximately 5-200 cubic inches and stores compressed air at a pressure of approximately 1-10 atmospheres. The compressed air is able to inflate the bladder (190) volume of approximately 1000-4000 cubic inches at a pressure ranging from 0.2-5 psi (controlled via a pressure regulator) to raise the wheelchair occupant with the raised seat (185). The compressed gas cylinder would contain enough compressed gas to raise the raised seat (185) several times before it would require recharging via an electrical pump that could be located at a convenient location within the home or location of choice for the wheelchair occupant. A controller (210) located at the armrest of the wheelchair (20), wheelchair frame (45), or a RF controlled remote control is used by the wheelchair occupant to control the inflation of the bladder (190) via a valve (215) (see FIG. 10C) such as a 3-way valve (215), for example, located between the compressed gas cylinder and the bladder (190) and in fluid communication with the tube that connects the compressed air cylinder with the bladder (190). The wheelchair occupant would inflate the bladder (190) to raise the raised seat (185) by several inches as shown in FIG. 10B during lateral transfer, and release air from the bladder (190) following lateral transfer.

The present raised seat assembly (180) embodiment can be used with other embodiments of the present invention; for example, if the seat were raised a few inches, the amount of required rearward travel of the sliding wheel would be less to accomplish a lateral transfer. Similarly, if the raised seat (185) were raised a few inches (2-4 inches, for example), then a forward sliding seat (145) would only have to slide forward by a few inches (approximately 2-4 inches, for example). Further, if the forward sliding seat (145) moved forward only a few inches (approximately 2-4 inches, for example), the rearward sliding wheel would only have to slide approximately 2-4 inches, for example, to allow for a lateral transfer without obstacle from the transfer wheel. It is understood that each of the embodiments of the present invention can be used along with other embodiments that result in one or more other embodiments that provide a wheelchair (20) of the present invention that enables the occupant to transfer laterally.

As described in FIGS. 3A-3C one embodiment of the present invention is a wheel assembly (72) that allows the transfer wheel (5) to slide rearward to allow the occupant of the wheelchair to transfer in front of the transfer wheel (5). Once the transfer wheel (5) has been slid rearward, or when the transfer wheel (5) is in its normal forward mobility position, it is necessary to provide a mechanism to lock the wheel assembly (72) to prevent sliding motion between the fixed member (95) and the slidable member (80). A slide-lock assembly (86) is described in FIGS. 11A-11C that prevents sliding motion of the slide assembly (75) by locking the slidable member (80) with respect to the fixed member (95) in any position along the length of the slide assembly (75). In addition, it is necessary that the transfer wheel (5) can be locked from rotational motion. A wheel-lock assembly (88) is described in FIGS. 11A-11C that provides the occupant of the wheel chair with the capability of locking the rotational motion of the transfer wheel (5) whether the wheel is located forward, rearward, or in any position along the slide assembly (75). The wheel-lock assembly (88) of the present invention can also be used as a brake to allow the occupant to slow the wheelchair down in speed when mobilizing the wheelchair (20) on a downward incline.

FIGS. 11A-11C shows an embodiment for a wheel assembly (72) of the present invention. The wheel assembly (72) is comprised of a transfer wheel (5) and a slide assembly (75). The slide assembly (75) has a fixed member (95) that is attached to the frame (45) of the wheelchair, a slidable member (80) that slides relative to the fixed member (95) and is attached to the transfer wheel (5), and a slide-lock assembly (86) that is attached to either the slidable member (80), the wheelchair axle (50), or to both. The slide-lock assembly (86) is comprised of a lock lever (85) that is pivotally attached to the axle (50) of the wheelchair; the lock lever (85) is rotationally attached to a slide arm (220) via a pivot (225) such that the slide arm (220) has a bias that is provided via a spring (227) (such as a torsion spring, for example) to cause a slide pin (230) to be biased toward an engagement hole (235) located in the fixed member (95); the slide pin (225) is held from engagement with the engagement hole (235) while the lock lever (85) is in a raised angle (240) by an arm stop (245) attached to the lock lever (85) (see FIG. 11A).

Upon activation of the lock lever (85) by the occupant downward to an intermediate angle (250) as shown in FIG. 11B, the slide pin (225) becomes engaged with an engagement hole (235) located in the fixed member (95). The fixed member (95) can have several engagement holds (range from 2 to 20) to provide a variety of positions for the transfer wheel (5) from its normal mobilization position (i.e., normal wheelchair configuration for forward locomotion) to a rearward direction for lateral transfer and in a forward direction to provide less strain on the muscles and ligaments during the initial backward reach and grasp by the occupant of the transfer wheel (5) at the start of a forward movement of the transfer wheel (5).

The slide assembly (75) of the present invention can also contain a wheel-lock assembly (88) as shown in FIGS. 11A-11C. The wheel-lock assembly (88) is comprised of a lock lever (85) that is pivotally attached to the axle (50) of the wheelchair, a wheel-lock toggle (255) that is pivotally attached to the lock lever (85), and a lock ring (260) that is attached to the transfer wheel (5). When the lock lever (85) is located at a raised angle (240), a lock tang (265) attached to the wheel-lock toggle (255) does not make contact with the lock ring (260) as shown in FIG. 11A; the transfer wheel (5) is free to undergo rotational movement. Upon downward motion of the lock lever (85) to the lowered angle (270) as shown in FIG. 11C, the lock tang (265) pivots along a fixed lock post (275) attached to the slidable member (80) to place the lock tang (265) into forceful and frictional contact with the lock ring (260) to cause rotation of the transfer wheel (5) to begin braking or to cease rotational motion. This frictional interaction between the lock tang (265) and the lock ring (260) can be used to provide a locking of the transfer wheel (5) to prevent rotational motion of the wheel from a stopped position; also, this frictional interaction can be used to provide a braking action that can be used to slow the wheelchair down in a controlled manner from a wheelchair rolling motion to a controlled stop by breaking the motion of the transfer wheel (5). The frictional interaction of the lock tang (265) with the lock ring (260) can be similar in interaction and materials as those found in disc brakes of an automobile, for example. In the intermediate angle (250) for the lock lever (85), the lock tang (265) does not yet make contact with the lock ring (260) as shown in FIG. 11B. It is noted that the lock lever (85) can be used to provide both a locking of the sliding motion between the slidable member (80) and the fixed member (95) as well as lock the transfer wheel (5) to prevent rotational motion of the transfer wheel (5).

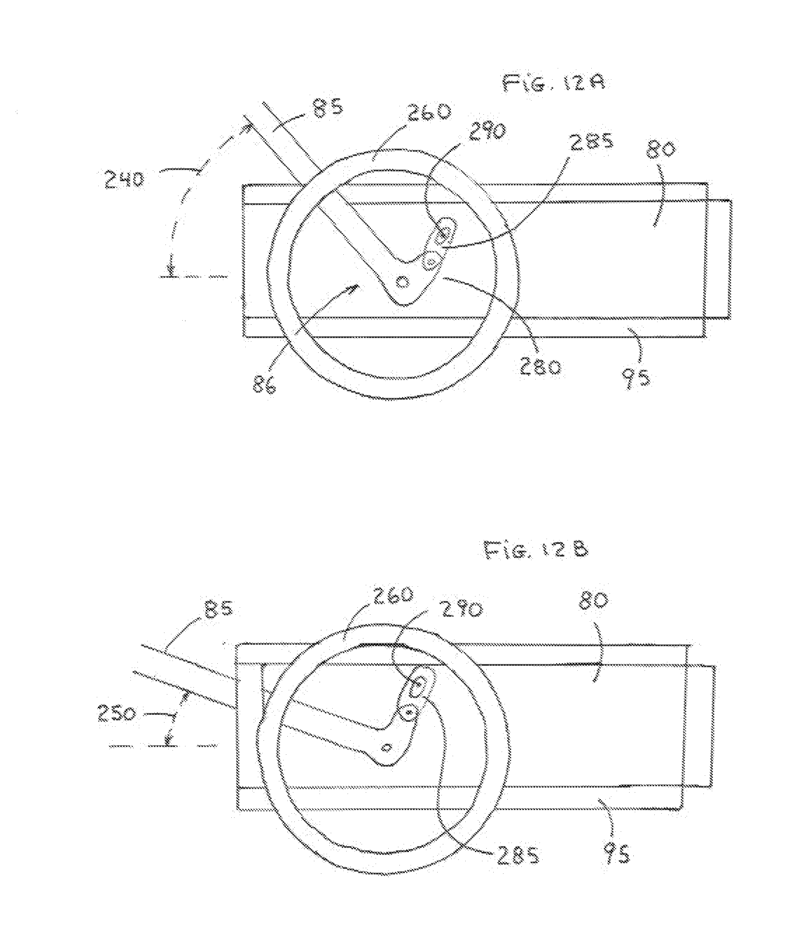

An alternate embodiment for the slide-lock assembly (86) is shown in FIGS. 12A and 12B. In this embodiment the slide lock assembly has a slide-lock toggle (280) that is pivotally attached to the lock lever (85). With the lock lever (85) in the raised angle (240), the slide tang (285) does not make contact with the fixed member (95) of the slide assembly (75). Upon activation of the lock lever (85) to an intermediate angle (250), the slide tang (285) pivots along a fixed slide post (290) attached to the slidable member (80), causes the slide tang (285) to make direct forceful and frictional contact with the fixed member (95) causing relative motion between the slidable member (80) and the fixed member (95) to cease. In this embodiment the slidable member (80) and hence the transfer wheel (5) can be positioned anywhere along the fixed member (95) of the slide assembly (75).

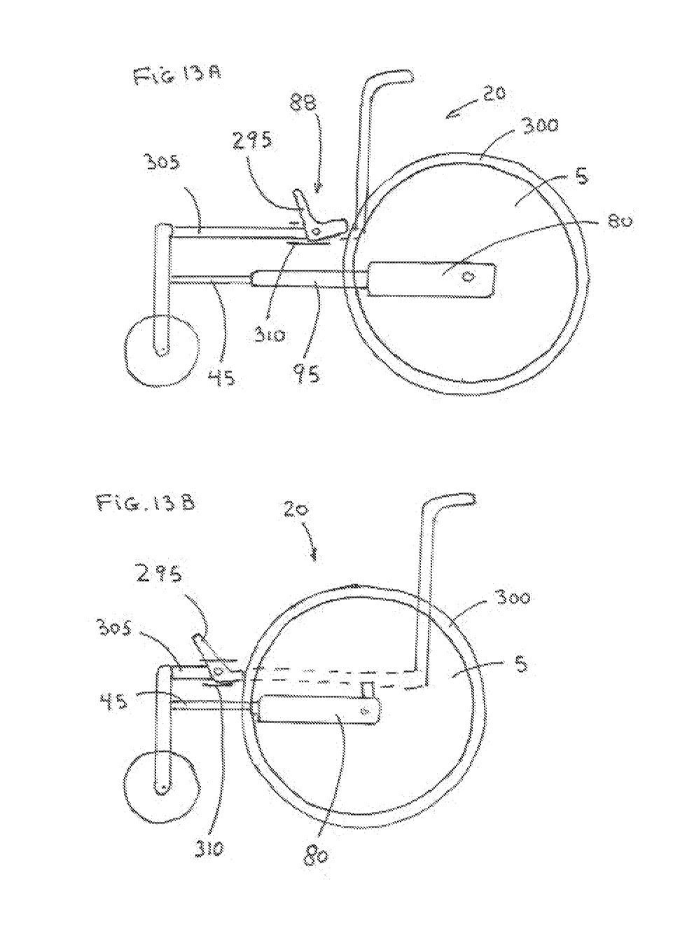

Another alternate embodiment for the wheel-lock assembly (88) for a wheelchair (20) of the present invention having a transfer wheel (5) that is able to be moved rearward is shown in FIG. 13. A slidable lever (295) that makes direct contact with the rubber outer portion (300) of a standard transfer wheel (5) is positioned along a horizontal portion (305) of a wheelchair frame (45). The slidable lever (295) makes a toggle contact with the rubber portion of the transfer wheel (5) to lock the transfer wheel (5) in a manner similar to the locking levers found on standard wheelchairs (see FIG. 13B). As the transfer wheel (5) is positioned rearward to provide the occupant with an opportunity for lateral transfer as shown in FIG. 13A, the slidable lever (295) is also slid rearward along the horizontal portion (305) of the frame (45) to meet with direct contact with the transfer wheel (5). An adjustable hold element (310) can be used to hold the slidable lever (295) in position along the horizontal portion (305) of the wheelchair frame (45). An automatic hold element (310) can also hold the slidable lever (295) in position along the horizontal portion (305); such hold elements (310) include ratchets, pins, spring-loaded gripping mechanisms.

It is understood that the present invention is not limited to the slide-lock assemblies and wheel-lock assemblies shown in this application and that other mechanism have also been anticipated.

1-19. (canceled)

20. A transfer wheel for a wheel chair comprising;
A. a non-chordal segment that is adapted to be mounted onto an axle of said wheel chair, said non-chordal segment having a non-chordal surface,
B. a chordal segment having a chordal surface that is adapted to be attached to said non-chordal surface to form said transfer wheel with a round assembled shape,
C. said chordal surface being further adapted to be detached from said non-chordal surface to form said transfer wheel with a non-round disassembled shape,
D. said chordal surface being held into contact with said non-chordal surface by sliding interlocking surfaces to form said round assembled shape,
E. said sliding interlocking surfaces being adapted to release said chordal surface from said non-chordal surface to provide said transfer wheel with an unobstructed passage for an occupant of said wheel chair over said non-chordal surface for lateral transfer.

21. The transfer wheel of claim 20 wherein said sliding interlocking surfaces comprise protruding elements that extend from said chordal surface and receptacle elements located on said non-chordal surface.

22. The transfer wheel of claim 21 wherein said protruding elements are inclined protruding elements that extend into receptacle elements comprising inclined receptacle elements.

23. The transfer wheel of claim 21 wherein said protruding elements are locator pins that extend into receptacle elements that are locator holes.

24. The transfer wheel of claim 21 wherein said protruding elements comprise a cam latch mechanism and said receptacle elements comprise a cam seat.

25. The transfer wheel of claim 20 wherein said chordal segment comprises a chord angle ranging from 90 to 180 degrees of said transfer wheel.

26. The transfer wheel of claim 20 wherein said chordal segment comprises a chord angle ranging from 110 to 170 degrees of said transfer wheel.

27. The transfer wheel of claim 20 further comprising a wheel lift for raising said transfer wheel off of the ground.

28. A transfer wheel for a wheel chair comprising;
A. a non-chordal segment that is adapted to be mounted onto an axle of said wheel chair, said non-chordal segment having a non-chordal surface,
B. a chordal segment having a chordal surface that is adapted to be attached to said non-chordal surface to form said transfer wheel with a round assembled shape,
C. said chordal surface being further adapted to be detached from said non-chordal surface to form said transfer wheel with a non-round disassembled shape,
D. said chordal surface being held into contact with said non-chordal surface by sliding interlocking surfaces to form said round assembled shape, said sliding interlocking surfaces comprising protruding elements that extend from said chordal surface and receptacle elements located on said non-chordal surface,
E. said sliding interlocking surfaces being releasable to release said chordal surface from said non-chordal surface to provide said transfer wheel with an unobstructed passage for an occupant of said wheel chair over said non-chordal surface for lateral transfer.

29. A transfer wheel for a wheel chair comprising;
A. a non-chordal segment that is adapted to be mounted onto an axle of said wheel chair, said non-chordal segment having a non-chordal surface,
B. a chordal segment having a chordal surface that is adapted to be attached to said non-chordal surface to form a perimeter for said transfer wheel having a round assembled shape,
C. said chordal surface being further adapted to be detached from said non-chordal surface to form said transfer wheel with a non-round disassembled shape,
D. said chordal surface being held into contact with said non-chordal surface by sliding interlocking surfaces to form said round assembled shape, said sliding interlocking surfaces comprising protruding inclined surfaces that extend from said chordal surface and inclined receptacle surfaces located on said non-chordal surface.
